(19) United States
(12) Patent Application Publication
(10) Pub. No.: US 2025/0210986 A1
(43) Pub. Date: Jun. 26, 2025

(54) TOOL AND METHOD FOR OPERATING A TOOL

(71) Applicant: ANDREAS STIHL AG & Co. KG, Waiblingen (DE)

(72) Inventors: Ingo KUGLER, Waiblingen (DE); Sascha KÄLBER, Aichwald (DE)

(73) Assignee: ANDREAS STIHL AG & Co. KG, Waiblingen (DE)

(21) Appl. No.: 18/989,415

(22) Filed: Dec. 20, 2024

(30) Foreign Application Priority Data
Dec. 22, 2023 (DE) 10 2023 136 568.1

(51) Int. Cl. H02J 3/00; B25F 5/02

(52) U.S. Cl. CPC H02J 3/001; B25F 5/02

(57) ABSTRACT

A tool, in particular a mobile and/or hand-held tool, includes: a drive unit that is configured to convert electrical energy to drive a tool element of the tool; a contact element for transmitting electrical energy and/or electrical signals and which is configured to form a disconnectable terminal connection with a supply device for providing electrical energy and/or electrical signals to be able to provide electrical energy and/or electrical signals to the drive unit in a connection state of the supply device; and an intermediate circuit that electrically connects the drive unit to the contact element. The intermediate circuit has a circuit arrangement that is configured to reduce or to switch off an electrical voltage that is applied to the contact element after a disconnection process of the supply device and/or in a disconnection state of the supply device as a function of at least one defined operating information.

### CROSS-REFERENCE TO RELATED APPLICATIONS

This application claims priority under 35 U.S.C. § 119 to German patent application DE 10 2023 136 568.1, filed Dec. 22, 2023, the entire disclosure of which is incorporated herein by reference.

### BACKGROUND OF THE DISCLOSURE

### 1. Field of the Disclosure

The present disclosure is in the field of electrical drive technology and relates to a tool, in particular a hand-held and/or portable power tool, with a drive unit for converting electrical energy in order to drive at least one tool element of the tool. The present disclosure also relates to a method for operating the tool.

### 2. Description of Related Art

Electrically powered tools (power tools) are used in many different areas and industries, for example, in the kitchen area, gardening, agriculture, and forestry, in the plant and process industry, or in the field of medical technology and building services engineering. To enable cordless and flexible handling, mobile hand-held tools, for example, are now often equipped with rechargeable accumulators that can provide stored electrical energy. A manually detachable plug-in connection or a manually detachable plug-in snap-in connection is usually formed between the tools and the accumulators, which should be easy and, above all, safe to handle.

For the electrical connection of an accumulator, a tool has respective contact elements for corresponding mating contact elements of the accumulator. The contact elements of such tools are usually located in an exposed location in a plug-in section of the tool housing. As a result, the contact elements are more or less freely accessible after the accumulator is disconnected from the tool and can be touched with fingers, for example.

Any voltage remaining on the contact elements (residual voltage) can pose a danger to the user of the tool, which must be avoided. The residual voltage on the contact elements after removing the accumulator as the main power source can be generated, for example, by a required capacitor or by another electrical storage device of the tool.

In order to counteract the danger of electric shock by touching freely accessible or exposed contact elements, various approaches are known from the prior art patent literature.

For example, Chinese utility model specification No. CN 209526143 U relates to a power tool with a housing and a battery pack that can be detachably plugged into the housing in order to operate the power tool. Inside the housing there is a tool circuit with a capacitor, which is charged by the battery pack during use of the power tool. In order to reduce the danger of electric shock at the terminal connections due to a discharge process of the capacitor after the battery pack has been disconnected from the power tool, the power tool has a mechanical contact protection in the form of a movably mounted protective element with a protective cover, which is supported on the housing via a spring and covers the terminal connections when the battery pack is disconnected. In addition, the tool circuit includes an electrical protection mechanism in the form of a resistor. If the battery pack is disconnected from the housing, the resistor is connected in series with the tool circuit via the movable protective element in order to consume the stored residual energy of the capacitor. If the battery pack is plugged into the housing, the resistor is disconnected from the tool circuit and is, therefore, not permanently connected to the tool circuit.

Furthermore, US patent application No. US 2019/0074489 A1 describes a portable backpack power supply device with a battery pack that can be connected to a motor of a power tool in the form of a garden shear to drive the motor. The battery pack is connected to a two-part, L-shaped base body of the backpack by means of a plug connection in order to carry it. To connect and transmit electrical energy, the base body has an input interface with plate-shaped contact elements and an output interface in the form of a plug connector. A safety switch that can be mechanically actuated by a contact element is electrically connected between the input interface and the output interface. When the battery pack is plugged into the base body, the safety switch is in a first state, according to which the input interface is connected to the output interface. After disconnecting the battery pack from the base body, the electrical connection between the input interface and the output interface is disconnected. In this case, when the output interface is connected to a tool, electricity from a capacitor and other electrical storage devices of the tool cannot be transmitted to the input interface, which is to help prevent electric shock by touching the input interface.

German publication no. DE 10 2017 108 075 A1 describes an electric circular saw that comprises a power supply area for generating a DC voltage to drive the motor by rectifying an AC voltage supplied by an AC voltage source and smoothing it by means of a capacitor. A controller controls the electrical power supply to the motor through the power supply area, and a voltage detector detects the AC voltage. The controller is configured to interrupt the power supply if the voltage detector does not detect any AC voltage. In this case, a discharger, which has a resistor and a transistor, discharges the electrical charge of the capacitor based on a command from the controller. The resistor and the transistor are connected in parallel with the capacitor. A further resistor connected in parallel with the capacitor is used to gradually discharge accumulated electrical charge on the capacitor when the power supply from the AC voltage source is stopped.

### SUMMARY OF THE DISCLOSURE

It is an object of the present disclosure to provide an electric tool that is characterized above all by improved electrical safety during handling. Furthermore, it is an object of the present disclosure to provide a method for operating an electric tool which, in particular, ensures safe handling of the tool.

The object is achieved by the features set forth in the claims. Further embodiments and applications of the present disclosure are explained in more detail in the following description with partial reference to the figures.

According to a first general aspect, the present disclosure relates to a tool, in particular a mobile and/or hand-held tool, comprising a drive unit which is configured to convert electrical energy in order to drive at least one tool element of the tool; at least one contact element for transmitting electrical energy and/or electrical signals, which is configured to form a disconnectable terminal connection with at least one supply device for providing electrical energy and/or electrical signals, in order to be able to provide electrical energy and/or electrical signals to the drive unit in a connection state of the at least one supply device; an intermediate circuit which electrically connects the drive unit to the at least one contact element, wherein the intermediate circuit comprises a circuit arrangement that is configured for reducing and/or switching off, in particular for switching off, an electrical voltage, which is present at the at least one contact element after a disconnection process of the at least one supply device and/or in a disconnection state of the at least one supply device, as a function of at least one defined operating information.

The present disclosure can provide a tool in the form of a power tool (electrical device) that offers effective protection, in particular finger contact protection, in relation to at least one exposed or freely accessible contact element. For example, the danger of electric shock during handling of the tool can be avoided.

The at least one defined operating information can be a recorded, in particular measured, operating information and/or a calculated operating information, for example, a measured operating state and/or a measured operating parameter and/or a calculated operating state and/or a calculated operating parameter.

The at least one defined operating information can comprise and/or represent and/or be associated with an operating state of the drive unit and/or a change of the operating state of the drive unit, in each case for a defined and/or recorded period of time before the disconnection process and/or before the disconnection state; and/or the at least one defined operating information can comprise and/or represent and/or be associated with an operating state of the drive unit and/or a change of the operating state of the drive unit, in each case for a defined and/or recorded period of time after the disconnection process and/or during the disconnection state.

The at least one defined operating information can comprise and/or represent and/or be associated with at least one of the following operating states: an activation state of the drive unit, in which electrical energy of the at least one supply device is provided to the drive unit in order to drive the at least one tool element; a generator state of the drive unit, in which the drive unit generates electrical energy and feeds it into the intermediate circuit; and/or a standstill of the drive unit, in which no electrical energy is provided to the drive unit and/or the drive unit is stationary.

The operating state can also be an idle state, which is, for example, an activation state without load.

According to a further aspect of the present disclosure, it can be provided that the at least one defined operating information comprises and/or represents and/or is associated with an operating parameter of the intermediate circuit and/or a change of the operating parameter of the intermediate circuit, in each case for a defined and/or recorded period of time before the disconnection process and/or before the disconnection state; and/or that the at least one defined operating information comprises and/or represents and/or is associated with an operating parameter of the intermediate circuit and/or a change of the operating parameter of the intermediate circuit, in each case for a defined and/or recorded period of time after the disconnection process and/or during the disconnection state.

The operating parameter can be a generated and/or a recorded voltage of the intermediate circuit or a generated and/or a recorded voltage curve of the intermediate circuit. The operating parameter can also be a state of charge of at least one electrical storage element of the intermediate circuit.

According to a further aspect of the present disclosure, it can be provided that the at least one defined operating information comprises and/or represents and/or is associated with an operating parameter of the drive unit and/or a change of the operating parameter of the drive unit in each case for a defined and/or recorded period of time before the disconnection process and/or before the disconnection state; and/or in that the at least one defined operating information comprises and/or represents and/or is associated with an operating parameter of the drive unit and/or a change of the operating parameter of the drive unit in each case for a defined and/or recorded period of time after the disconnection process and/or during the disconnection state.

The operating parameter can be a speed or a speed curve of the drive unit. The operating parameter can be a torque or a torque curve of the drive unit.

It is possible that the at least one defined operating information comprises at least one recorded, in particular measured, voltage value or at least one recorded, in particular measured, voltage value curve, which in each case is associated with at least one of the following components of the tool: the at least one contact element; the drive unit; at least one main line of the intermediate circuit between the at least one contact element and the circuit arrangement; at least one main line of the intermediate circuit between the circuit arrangement and a drive unit circuit for the drive unit; and/or at least one main line of the intermediate circuit between the at least one contact element and a drive unit circuit for the drive unit, which comprises the circuit arrangement.

According to a further aspect of the present disclosure, it can be provided that the circuit arrangement is arranged and/or configured to reduce, in particular to switch off, the present voltage within a defined period of time after detection of the disconnection process and/or the disconnection state; and/or that the circuit arrangement is arranged and/or configured to reduce a voltage value of the present voltage at least to or below a defined maximum voltage value after detection of the disconnection process and/or the disconnection state.

It is possible that the circuit arrangement comprises a voltage control module for the at least one contact element, which is arranged between the at least one contact element and a drive unit circuit for the drive unit.

According to a further aspect of the present disclosure, it can be provided that the voltage control module comprises at least one switching unit with at least one switching element, wherein the at least one switching element is formed as at least one of the following switching elements or comprises at least one of the following switching elements: a metal-oxide semiconductor field-effect transistor (abbreviated to “MOSFET”), a bipolar transistor with an insulated-gate electrode (abbreviated to “IGBT”).

With switching elements in the form of semiconductor switching elements, for example, switching operations with very short period of time can be realized.

It is possible that the circuit arrangement comprises a storage control module for at least one storage element of a drive unit circuit for the drive unit, which is arranged in particular in a parallel circuit on the drive unit circuit, wherein, in particular, the storage control module comprises at least one switching element and at least one resistor element, which are arranged in a series circuit with respect to one another, wherein for example the at least one resistor element is formed as at least one of the following resistors or comprises at least one of the following resistors: a constant resistor; and/or a variable resistor.

According to a further aspect of the present disclosure, it can be provided that the tool comprises at least one sensor unit for recording the at least one defined operating information, wherein, in particular, the at least one sensor unit is integrated in a microprocessor module for controlling and/or regulating the tool or is at least connected to the microprocessor module via a communication link.

According to a further aspect of the present disclosure, it can be provided that the tool comprises at least one communication unit which is configured for detecting the disconnection process and/or the disconnection state and/or the connection state of the at least one supply device, wherein, in particular, the at least one communication unit is integrated in a microprocessor module for controlling and/or regulating the tool. In particular, the microprocessor module can be configured for detecting the disconnection process and/or the disconnection state and/or the connection state of the at least one supply device.

According to a second general aspect, the present disclosure relates to a method for operating a tool, in particular a mobile and/or hand-held tool, wherein, in particular, the tool is formed as disclosed herein, wherein the tool comprises a drive unit for converting electrical energy in order to drive at least one tool element of the tool; wherein the tool comprises at least one contact element for transmitting electrical energy and/or electrical signals, wherein at least one supply device for providing electrical energy and/or electrical signals and the at least one contact element form a disconnectable terminal connection in order to be able to provide electrical energy and/or electrical signals to the drive unit in a connection state of the at least one supply device, and wherein the tool comprises an intermediate circuit with a circuit arrangement which electrically connects the drive unit to the at least one contact element, wherein the method comprises: detecting a disconnection process and/or a disconnection state between the at least one supply device and the at least one contact element; recording an electrical voltage which is present at the at least one contact element; reducing and/or switching off, in particular switching off, the electrical voltage at the at least one contact element by the circuit arrangement as a function of at least one defined operating information.

Reducing the voltage can comprise generating a voltage drop at the at least one contact element and/or at the intermediate circuit by the circuit arrangement within a defined period of time after detecting the disconnection process and/or the disconnection state, wherein, in particular, the voltage drop over the defined period of time is characterized by at least one of the following curves: an essentially rectangular curve, an essentially linear curve, and/or an essentially exponential curve; generating a voltage drop at the at least one contact element and/or at the intermediate circuit by the circuit arrangement to or below a defined maximum voltage value, wherein, in particular, the defined maximum voltage value is an adjustable and/or a calculated and/or a stored maximum voltage value.

Detecting the disconnection process can comprise: transmitting at least one communication signal from the at least one supply device to the intermediate circuit and/or from the intermediate circuit, in particular from a microprocessor module for controlling and/or regulating the tool, to the at least one supply device, wherein the at least one communication signal is configured for verification of the presence and/or absence of a communication link between the at least one supply device and the intermediate circuit; and evaluating the transmitted at least one communication signal and identifying the connection state, the disconnection process and/or the disconnection state as a function of the evaluated at least one communication signal, in particular in each case by the microprocessor module for controlling and/or regulating the tool, wherein, in particular, evaluating the transmitted at least one communication signal comprises: comparing with at least one communication reference signal and/or at least one communication threshold signal as a function of at least one comparison parameter; and/or storing the transmitted at least one communication signal.

Recording the electrical voltage can comprise: measuring at least one voltage value or at least one voltage value curve at the at least one contact element by at least one sensor unit of the tool, in particular for a defined period of time, and reducing and/or switching off, in particular switching off, the electrical voltage, if the measured at least one voltage value or the measured at least one voltage value curve is in each case equal to or greater than a defined maximum voltage value or a defined maximum voltage value curve, in particular after an activation state of the drive unit, in which electrical energy from the at least one supply device is provided to the drive unit in order to drive the at least one tool element; or if the measured at least one voltage value or the measured at least one voltage value curve is in each case equal to or less than a defined maximum voltage value or a defined maximum voltage value curve, in particular in the case of a recorded generator state of the drive unit, in which the drive unit generates electrical energy and feeds it into the intermediate circuit.

According to a further aspect of the present disclosure, it can be provided that the method comprises: recording a deceleration period of time duration between the detection of the disconnection process and the drive unit reaching a standstill, during which no electrical energy is provided to the drive unit and/or in which the drive unit is stationary; reducing and/or switching off the electrical voltage at the at least one contact element and/or in the intermediate circuit as a function of the recorded deceleration period of time duration, in particular after the drive unit has reached a standstill.

In order to avoid repetition, features directed purely to the apparatus of the tool according to the disclosure and/or disclosed in connection therewith should also be regarded as disclosed according to the method and be claimable and vice versa.

### BRIEF DESCRIPTION OF THE DRAWINGS

The embodiments and features of the present disclosure described above can be combined with one another in any manner. Further or other details and advantageous effects of the present disclosure are explained in more detail below with reference to the accompanying figures.

FIG. 1 shows a schematic illustration of a first embodiment of the tool according to the present disclosure.

FIG. 2 shows a schematic illustration of a second embodiment of the tool according to the present disclosure.

FIG. 3 shows a time course of defined operating information during execution of a first embodiment of the method according to the present disclosure in a schematic illustration as a function of a first operating event.

FIG. 4 shows a time course of defined operating information during execution of the first embodiment of the method according to the present disclosure in a schematic illustration as a function of a second operating event.

FIG. 5 shows a time course of defined operating information during execution of a second embodiment of the method according to the present disclosure in a schematic illustration as a function of a first operating event.

FIG. 6 shows a time course of defined operating information during execution of the second embodiment of the method according to the present disclosure in a schematic illustration as a function of a second operating event.

### DETAILED DESCRIPTION OF THE DISCLOSURE

The present disclosure is not limited to the described embodiments. Rather, a large number of variants and modifications are possible which also make use of the inventive concept of the present disclosure and therefore fall within the scope of protection. In particular, the present disclosure also claims protection for the subject matter and features of the subclaims independently of the referenced claims.

In the following, in relation to device/s, element/s, unit/s, as well as signal/s, information/s and/or property/s, the expression “at least one” is omitted where appropriate for the sake of simplicity. It is understood that, for example, instead of one device/unit also several devices/units and/or instead of one signal/information/property also several signals/information/properties can be included or are included.

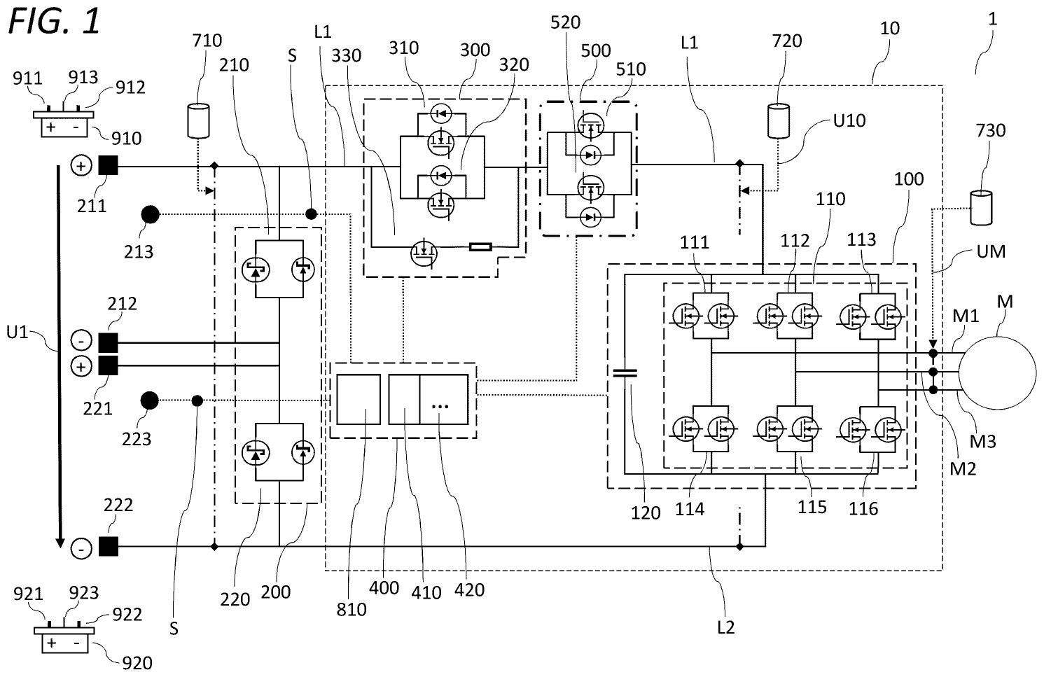

FIG. 1 shows a schematic illustration of a first embodiment of the tool 1 according to the present disclosure.

The tool 1 can be a mobile and/or hand-held and/or hand-guided electrical tool 1 (power tool, electrical device). The tool 1 can be a manually operable tool 1. The tool 1 can, for example, be formed as one of the following and/or comprise at least one of the following: a garden tool, for example in the form of a mower, a trimmer, a scarifier, a shear, a scythe, a blower; a forestry tool, for example in the form of a chainsaw; a cleaning tool, for example in the form of a high-pressure cleaner; an assembly tool, for example in the form of a drill, a percussion drill, a hammer, a cut-off grinder, a saw; an agricultural tool for working the soil, for example in the form of a mulcher; a carpentry tool, for example in the form of a planer; a kitchen/household tool, for example in the form of a mixer, a vacuum cleaner, a compressor. Further forms and configurations of the tool 1 are possible, for example for the medical technology sector.

The tool 1 according to the present disclosure is configured to form a disconnectable (detachable) connection with at least one supply device 910, 920. The disconnectable connection comprises, in particular, a disconnectable electrical connection (separable terminal connection) and/or a disconnectable mechanical connection (separable form-fit and/or force-fit connection).

The at least one supply device 910, 920 is, in a connection state, configured to provide electrical energy and/or electrical signals S to the tool 1. In particular, the connection state represents a state in which the at least one supply device 910, 920 is properly connected electrically and mechanically to the tool 1 in order to be able to realize an intended function of the tool 1, in particular while ensuring safety.

In the first embodiment shown in FIG. 1, the tool 1 is configured for disconnectable connection with two supply devices 910 and 920. Alternatively, it is possible that the tool 1 is configured for disconnectable connection with (only) one supply device 910, 920 or for disconnectable connection with more than two supply devices 910, 920.

Each supply device 910, 920 is formed in the form of a mobile, rechargeable accumulator 910 and 920 for providing a DC voltage as the supply voltage of the tool 1. The accumulator can comprise at least one lithium-ion cell or several lithium-ion cells connected in series and provide a nominal voltage of approximately 36 volts.

To form the disconnectable connection with the respective supply device 910, 920, the tool 1 comprises four contact elements 211, 212; 221, 222 in the form of load contact elements for transmitting electrical energy. The contact elements 211 and 212 form a first contact element pair 211, 212 and the contact elements 221, 222 form a second contact element pair 221, 222.

The supply device 910 comprises two contact elements 911 and 912 in the form of load contact elements for transmitting electrical energy, which are associated with the contact elements 211, 212 as mating contact elements 911, 912. The supply device 920 comprises two contact elements 921 and 922 in the form of load contact elements for transmitting electrical energy, which are associated with the contact elements 221, 222 as mating contact elements 921, 922.

The contact elements 211 and 221 can each be associated with the positive pole and the contact elements 212 and 222 can each be associated with the negative pole. By correspondingly arranging and electrically connecting the contact elements 211, 212; 221, 222 in the form of a series connection, for example, an increased overall voltage can be provided as the supply voltage for the tool 1. The supply voltage can thus be approximately 72 volts by the two series-connected supply devices 910 and 920 and can be provided to the tool 1 in the connection state. In other words, the tool 1 is characterized by a high-performance battery system with a nominal voltage of approximately 72 volts.

It is optionally possible for the tool 1 to comprise a protection module 200 for the supply devices 910 and 920, which is electrically connected to the contact elements 211, 212; 221, 222 accordingly. The protection module 200 comprises a first protection unit 210 and a second protection unit 220. The first protection unit 210 and the second protection unit 220 are connected in series with one another between the contact elements 211 and 222. The first protection unit 210 is in turn arranged between and/or associated with the contact elements 211 and 212, and the second protection unit 220 is in turn arranged between and/or associated with the contact elements 221 and 222. Both the first protection unit 210 and the second protection unit 220 each comprise two protection elements connected in parallel with one another in the form of a suppressor diode (transient voltage suppressor diode) and in the form of a Schottky diode (hot-carrier diode) and each serves, in particular, as an overvoltage protection unit, particularly in the case of brief voltage pulses, and/or as a reverse current protection unit for the respectively associated supply device 910, 920 in the connection state.

For communication with the respective supply device 910, 920 in the connection state, the tool 1 comprises in each case at least one contact element 213, 223 in the form of a signal contact element for transmitting electrical signals S between the respective supply device 910, 920 and the tool 1. For this purpose, the tool 1 can optionally comprise a communication unit 810 with, for example, a signal transmitter/receiver module and/or a communication interface module. The signal transmitter/receiver module and the communication interface module are not shown in the figures for reasons of clarity. The communication unit 810 can be a component of a microprocessor module 400 as the central module of the tool 1 for controlling and/or regulating modules 110, 300, 500, 600, units 111, 112, 113, 114, 115, 116, 310, 320, 330, 510, 520, 710, 720, 730 and/or elements 610 of the tool 1. The microprocessor module 400 comprises a computing unit 400 (microprocessor, CPU) and further units such as an interface unit 420, memory unit (RAM, flash), etc. The microprocessor module 400 can be configured to form a communication link with the supply devices 910, 920.

The tool 1 is further configured to form the disconnectable mechanical connection in the form of a plug-in connection or in the form of a plug-in snap-in connection with a respective supply device 910, 920. In particular, the disconnectable mechanical connection can be disconnected manually, so that no tool is required, for example, for mounting and removing the supply devices 910 and 920 on the tool 1. This ensures that the tool 1 is easy to handle.

However, a manually and thus tool-free disconnectable connection in the form of a disconnectable plug-in connection or a disconnectable plug-in snap-in connection can make it possible to disconnect the respective supply device 910, 920 from the tool 1, which represents a danger situation for the user of the tool 1 in certain situations, since the contact elements 211, 212; 221, 222 are then freely accessible. In other words, touching the contact elements 211, 212; 221, 222 can result in the danger of electric shock, particularly in the case of tools 1 that are operated with a nominal voltage of more than approximately 60 volts, for example, and a voltage U1 of more than approximately 60 volts is present to the exposed or freely accessible contact elements 211, 212; 221, 222 after a disconnection process.

It is understood that in order to form a plug-in connection or a plug-in snap-in connection, both the tool 1 and the supply devices 910, 920 each have mutually complementary plug-in sections and thus mutually complementary plug-in faces in order to realize the respective disconnectable, essentially form-fit and/or essentially force-fit, connection in a plug-in direction.

In other words, the tool 1 in FIG. 1 is a battery-operated tool 1 for connecting and/or comprising two supply devices 910 and 920 in the form of replaceable and/or rechargeable accumulators 910 and 920. Alternatively, it is possible that the at least one supply device 910, 920 is formed as a plug connector, for example in the form of a plug, and/or comprises at least one such plug connector, wherein the plug connector is in turn connected to a cable for providing electrical energy and/or electrical signals S, and wherein the plug connector is configured to form a manually disconnectable mechanical connection in the form of a plug-in connection or in the form of a plug-in snap-in connection with the tool 1.

The tool 1 comprises a drive unit M, which is configured to convert electrical energy in order to drive at least one tool element of the tool 1, in particular in an operating state. For reasons of clarity, the at least one tool element is not shown in the figures and can, depending on the form and/or configuration of the tool 1, comprise, for example, a cutting unit with cutting blades, a cutting disk, a pump, etc. A gearbox for converting the rotational speed and/or torque can be arranged between the drive unit M and the at least one tool element.

The drive unit M is, in particular, a rotary field machine in the form of a brushless three-phase motor M and is characterized, for example, by a comparatively high power density, efficiency and durability. The three-phase motor M comprises a stator as the stationary part and a rotor as the rotating part. The stator is equipped with electromagnets, i.e. coils or windings, and the rotor is equipped with permanent magnets (permanently excited rotor). The three-phase motor M is characterized by a three-phase winding in order to generate a wandering (rotating) magnetic field, i.e. a rotating magnetic field, by means of appropriate control and/or regulation in order to pull the rotor along and thus set it in a rotary movement. The rotor is in turn coupled to the at least one tool element, for example directly (immediate) or via a gearbox. The three phase inputs of the three-phase motor M are labelled in FIG. 1 with the three phase lines M1, M2 and M3.

The drive unit M can be formed as a known electric motor M, in particular as a known brushless three-phase motor M.

The tool 1 comprises an intermediate circuit 10, which electrically connects the drive unit M with the contact elements 211, 212; 221, 222, i.e. with the contact elements 211 and 222 resulting from the interconnection.

In the connection state of the supply devices 910 and 920, electrical energy can be provided to the drive unit M via the intermediate circuit 10 in order to operate the tool 1.

The intermediate circuit 10 comprises a first main line L1 and a second main line L2 for transmitting electrical energy. The first main line L1 is electrically connected to the contact element 211 and the second main line L2 is electrically connected to the contact element 222. In other words, the main lines L1 and L2 represent electrical power paths of the tool 1.

To operate the drive unit M, the intermediate circuit 10 comprises a drive unit circuit 100 with a switching module 110 and at least one storage element 120. The switching module 110 is an electronic switching module 110 and is used to supply the drive unit M with electrical energy and to commutate the drive unit M. The microprocessor module 400 is used for controlling and/or regulating the switching module 110.

Commutation of the drive unit M switches the current in the coils or windings of the stator of the drive unit M in order to generate the magnetic rotating field. The magnetic rotating field sets the rotor of the drive unit M in movement, which in turn drives the at least one tool element via a coupling. For this purpose, the switching module 110 comprises six switching units 111, 112, 113, 114, 115, 115, 116 with switching elements, which are not labelled in detail in the figures for reasons of clarity.

Each switching unit 111, 112, 113, 114, 115, 116 is formed in particular as a semiconductor switching unit with each two switching elements in parallel connection. Alternatively, it is possible that the respective semiconductor switching unit comprises one switching element in each case. In particular, each switching element is formed as a semiconductor switching element or comprises a semiconductor switching element, for example a metal-oxide semiconductor field-effect transistor (abbreviated to “MOSFET”) or a bipolar transistor with an insulated gate electrode (engl. “insulated-gate bipolar transistor”, abbreviated to “IGBT”). In other words, the switching units 111, 112, 113, 114, 115, 116 represent bridge transistors and form a six-pulse half-bridge circuit. The switching units 111 and 114 are electrically connected to the phase line M1, the switching units 112 and 115 to the phase line M2 and the switching units 113 and 116 to the phase line M3.

By controlling and/or regulating the switching module 110 by means of the microprocessor module 400, the DC voltage provided by the supply devices 910 and 920 is converted into a suitable three-phase current for operating the electric motor M. The speed and the (positive or negative) acceleration of the drive unit M can be controlled by means of pulse width modulation. In pulse width modulation, the switching units 111, 112, 113, 114, 115, 116 are alternately switched to conducting and blocking by the microprocessor module 400 as a function of the direction of rotation of the rotor.

The at least one storage element 120 is connected in parallel to the switching module 110 as an electrical storage element 120, i.e. connected in parallel to two switching units 111, 114; 112, 115 and 113, 116 arranged in series.

The at least one storage element 120 can be formed as at least one capacitor and/or comprise at least one capacitor, for example in the form of an electrolytic capacitor as a passive electronic component. In other words, the at least one storage element 120 can be an intermediate circuit capacitor.

The at least one storage element 120 can be formed and/or configured to smooth out voltage fluctuations in the DC voltage provided by the supply devices 910 and 920 as supply voltage, in particular with respect to voltage peaks and voltage dips. As a result, for example, a substantially stable DC voltage can be provided and supplied to the switching module 110. The at least one storage element 120 can additionally or alternatively be configured for filtering high-frequency interferences in the DC voltage as the supply voltage. Additionally or alternatively, the at least one storage element 120 can also serve as an energy storage device in the event of short-term failures of the DC voltage as supply voltage and provide electrical energy to the switching module 110.

It is optionally possible that a current limiting module 300 is connected between the drive unit circuit 100 and a contact element 211, 222 to protect the drive unit circuit 100. In the first embodiment of the tool 1 shown in FIG. 1, the current limiting module 300 is arranged on the first main line L1 and comprises at least a first switching unit 310, a second switching unit 320 and a third switching unit 330. The first switching unit 310 and the second switching unit 320 are connected in parallel with each other. The switching units 310 and 320, which are connected in parallel with one another, are in turn connected in parallel with the third switching unit 330. Each switching unit 310, 320, 330 comprises a switching element in the form of a semiconductor switching element, for example a metal-oxide semiconductor field-effect transistor. The switching elements of the switching units 310 and 320 are each connected in parallel with a rectifier element in the form of a diode. The switching element of the third switching unit 330 is connected in series with a resistor element. The current limiting module 300 can be controlled and/or regulated by the microprocessor module 400.

If the supply devices 910 and 920 are now disconnected from the tool 1 at a certain time (disconnection time) by an operating event in the form of a disassembly process (disconnection process), so that a disconnection state is subsequently given, it would be possible for a voltage U1 to be generated in the tool 1 and present to the contact elements 211 and 222, which could lead to an electric shock in the disconnection state of the supply devices 910 and 920 when the then freely accessible contact elements 211 and 222 are touched.

The electrical voltage U1 can, for example, be generated or produced by the at least one storage device 120 of the intermediate circuit 10, i.e., by a discharging process. The electrical voltage U1 can, for example, additionally or alternatively be generated or produced by the drive unit M, for example in a generator state, in which the rotor of the drive unit M moves and thus generates electrical energy and feeds it into the intermediate circuit 10 via the phase lines M1, M2, M3, so that the voltage U10 is present at the intermediate circuit. The movement of the rotor can result from a movement of the coupled tool element (for example in the form of a cutting disk or a cutting unit) until the drive unit M has reached a standstill over a defined period of time.

The intermediate circuit 10 comprises a circuit arrangement 500, which is configured for reducing and/or switching off, in particular switching off, the electrical voltage U1, which is present after a disconnection process of the at least one supply device 910, 920 and/or in a disconnection state of the at least one supply device 910, 920, in particular at the contact elements 211 and 222, as a function of at least one defined operating information.

The circuit arrangement 500 can be arranged and/or configured to reduce and/or switch off, in particular switch off, the present voltage U1 within a defined period of time after detecting the disconnection process and/or the disconnection state; and/or to reduce a voltage value of the present voltage U1 at least to or below a defined maximum voltage value U_max after detecting the disconnection process and/or the disconnection state.

A voltage U10 in the range of approximately 60 volts to approximately 100 volts, which would be generated, for example, by residual charge of the at least one storage element 120 and fed into the main lines L1 and L2, for example for a defined period of time of up to approximately 80 seconds after the disconnection process and/or the disconnection time, can thus be interrupted immediately or within a defined period of time, for example less than approximately 4 seconds after the disconnection process and/or the disconnection time, so that the contact elements 211, 222 in particular are essentially voltage-free and/or remain essentially voltage-free, i.e. the voltage U1 present there is essentially 0 volts.

The circuit arrangement 500 makes it possible to reduce the voltage U1, which is present at the contact elements 211, 222, to at least a defined maximum voltage value U_max, for example approximately 60 volts, or to a lower voltage value within a defined period of time, for example within approximately 4 seconds after a disconnection process and/or after a disconnection time. It is additionally or alternatively possible to switch off the voltage U1 within a defined period of time so that no more voltage U1 is present at the contact elements 211, 222.

The circuit arrangement 500 can comprise a voltage control module 500 for the contact element 211 or be formed as a voltage control module 500 for the contact element 211. In the first embodiment of the tool 1, the circuit arrangement 500 is arranged on the first main line L1 between the contact element 211 and the drive unit circuit 100 and comprises at least a first switching unit 510 with a switching element. The switching element is formed in the form of a semiconductor switching element, for example as a metal-oxide semiconductor field-effect transistor. The switching element can be controlled and/or regulated by the microprocessor module 400 as a function of the at least one defined operating information. By switching the switching element, a generated voltage U10 of the intermediate circuit 10 can no longer be transmitted to the contact elements 211 and 222, or at least at a defined reduced level, thus avoiding the danger of electric shock by touching the contact elements 211 and 222. In the first embodiment of the tool 1, the circuit arrangement 500 comprises two switching units 520 and 520 connected in parallel to one another due to the design of the tool 1, which in particular are formed and/or configured identically to one another. As can be seen from FIG. 1, in addition to the respective switching element, each switching unit 510 and 520 also comprises a diode as a so-called body diode, which is connected in parallel with the respective switching element. The respective diode can be optional. For reasons of clarity, the switching elements and diodes of the switching units 510 and 520 are not labelled in detail in the figures.

The at least one defined operating information can comprise at least one operating state of the tool 1 and/or at least one operating parameter of the tool 1, which is or has been recorded, for example, by at least one sensor unit 710, 720, 730. The at least one defined operating information can additionally or alternatively be a calculated operating information. The microprocessor module 400 can be configured, inter alia, for processing and/or evaluating the at least one operating information as disclosed herein and, as a function of the processed and/or evaluated at least one operating information, to regulate and/or control the circuit arrangement 500, i.e., the voltage control module 500.

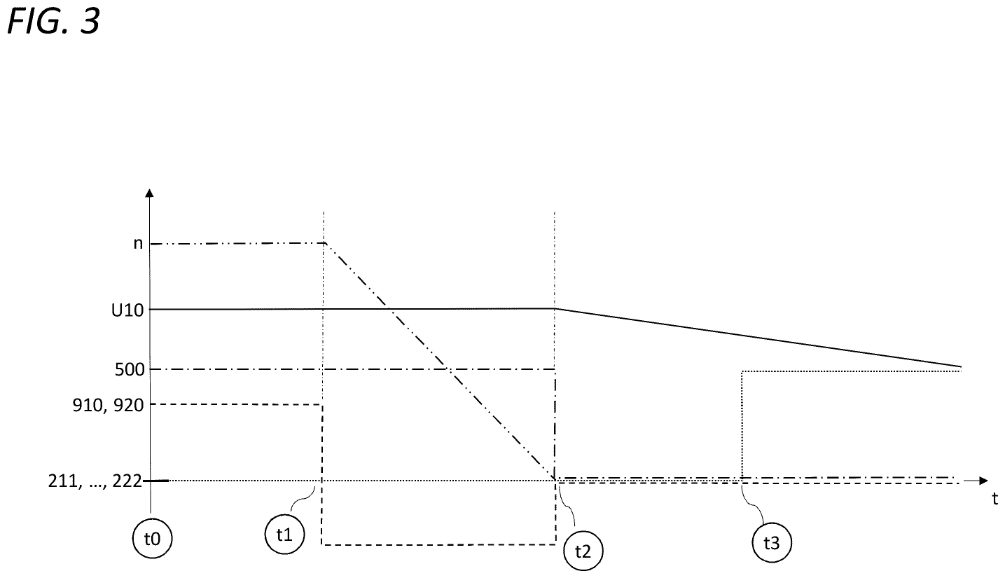

The defined operating information can comprise an operating state of the drive unit M and/or of the intermediate circuit 10, and/or a change of the operating state of the drive unit M and/or of the intermediate circuit 10, in each case for a defined and/or recorded period of time before the disconnection process and/or before the disconnection state. Additionally or alternatively, the defined operating information can comprise an operating state of the drive unit M and/or of the intermediate circuit 10, and/or a change of the operating state of the drive unit M and/or of the intermediate circuit 10, in each case for a defined and/or recorded period of time after the disconnection process and/or during the disconnection state. The same can apply to the defined operating information in the form of an operating parameter of the drive unit M and/or of the intermediate circuit 10, and/or to the defined operating information in the form of a change of an operating parameter of the drive unit M and/or of the intermediate circuit 10 (see also the description of FIGS. 3 to 6).

The defined operating information can above all comprise at least one recorded, in particular measured, voltage value or at least one recorded, in particular measured, voltage value curve, which is in each case associated with at least one of the following components of the tool 1: the contact elements 211, 212; 221, 222, the drive unit M; at least one main line L1, L2 between the contact elements 211, 212; 221, 222 and the circuit arrangement 500; at least one main line L1, L2 between the circuit arrangement 500 and the drive unit circuit 100.

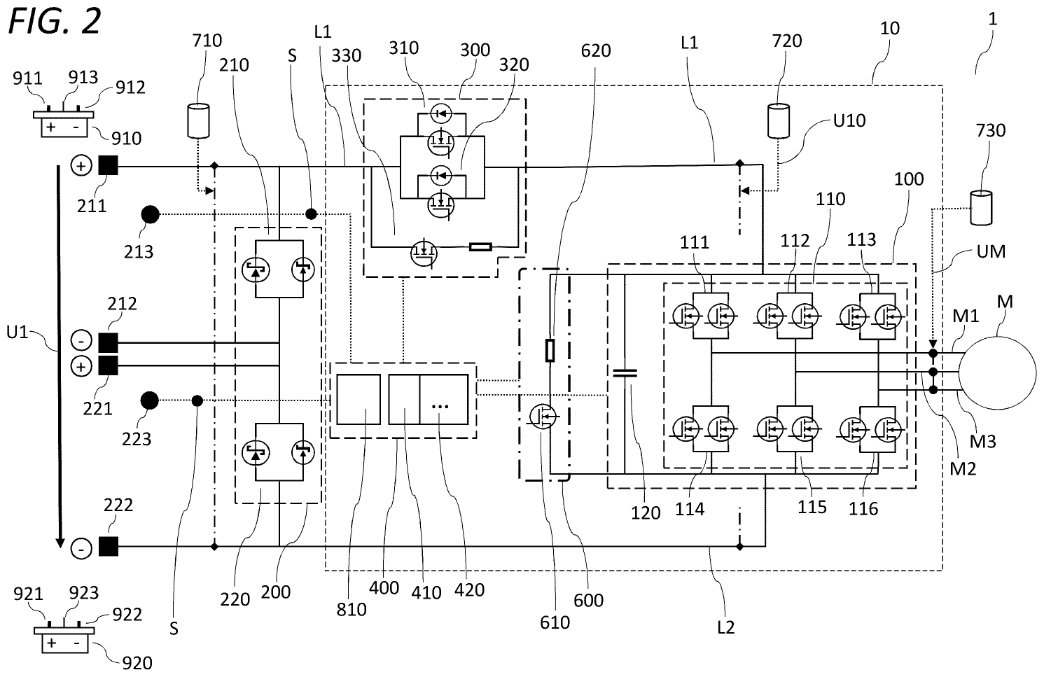

FIG. 2 shows a schematic illustration of a second embodiment of the tool 1 according to the present disclosure.

The second embodiment of the tool 1 is very similar to the first embodiment of the tool 1, so that identical components are not described in order to avoid repetition.

The tool 1 of the second embodiment does not comprise a circuit arrangement 500, which is arranged on and/or at the first main line L1. Instead, the tool 1 of the second embodiment comprises a circuit arrangement 600 in the form of a storage control module 600 for the at least one storage element 120. The storage control module 600 is connected in a parallel circuit to the drive unit circuit 100 and, in particular, in parallel to the at least one storage element 120. The storage control module 600 comprises at least one switching element 610 and at least one resistor element 620, which are arranged in a series circuit, i.e. connected in series with one another.

The at least one resistor element 620 can, for example, be formed as a constant resistor or as a variable resistor, in particular as a function of the configuration of the at least one storage element 120, for example with respect to a capacitance of the at least one storage element 120 as a defined operating information.

The storage control module 600 is associated with the at least one storage element 120 and is configured to cause a discharge of the at least one storage element 120 via the at least one resistor element 620 when the switching element 610 is switched accordingly, in order to avoid the generation of a voltage U10 of the intermediate circuit 10 and the feeding of this voltage into the main lines L1, L2.

In particular, the microprocessor module 400 is configured to detect a disconnection process and/or the disconnection time and/or the disconnection state by means of a communication link between the microprocessor module 400 and the supply devices 910, 920 and, as a function thereof, to regulate and/or control the circuit arrangement 500 and/or the circuit arrangement 600 in order to reduce and/or switch off, in particular switch off, a voltage U1 present to the contact elements 211, 222 in a defined manner.

FIG. 3 shows a time course of defined operating information during execution of a first embodiment of the method according to the present disclosure in a schematic illustration as a function of a first operating event. The first embodiment of the method can be carried out, for example, with the tool 1 according to the first embodiment as disclosed herein.

FIG. 3 shows a time course of the rotational speed n of the drive unit M, a time course of the voltage U10 of the intermediate circuit 10, a time course of the switching position of the circuit arrangement 500, a time course of the energy provided by the supply devices 910, 920, and a time course of the accessibility of the contact elements 211, 212, 221, 222 on the tool 1.

The supply devices 910, 920 are in a connection state at time to and the tool 1 is operated in an intended operating state, i.e. in an activation state, in which electrical energy from the supply devices 910, 920 is provided to the drive unit M in order to drive the at least one tool element.

At time t1, the tool 1 is switched off so that the supply of electrical energy by the supply devices 910, 920 to the drive unit M is interrupted (see the drop in the dashed line 910, 920 at t1 in FIG. 3) and the rotational speed n of the drive unit M decreases to zero by time t2.

When or after the drive unit M reaches a standstill at time t2 after a deceleration period of time as further defined operating information, in which no electrical energy is provided to the drive unit M and/or the drive unit M is stationary, the circuit arrangement 500 is switched, in particular by the microprocessor module 400 controlling and/or regulating, in order to switch off the voltage U10 of the intermediate circuit 10, so that no voltage U10 is present as voltage U1 at the contact elements 211, 212, 221, 222 at and/or after time t2.

At time t3, a disconnection process of the supply devices 910, 920 from the tool 1 takes place as the first operating event, so that the contact elements 211, 212, 221, 222 are freely accessible from time t3 (see the course of the dotted line 211, . . . , 222 in FIG. 3). However, the contact elements 211, 212, 221, 222 have been in a de-energized state since time t2 due to the voltage U1 having already been switched off by means of the circuit arrangement 500, so that they no longer pose any danger at and/or after time t3.

The voltage U1 at the contact elements 211, 212, 221, 222 and/or the voltage U10 in the intermediate circuit 10 can be switched off as a function of the detected deceleration time, in particular after the drive unit M has reached a standstill, in particular within a defined period of time.

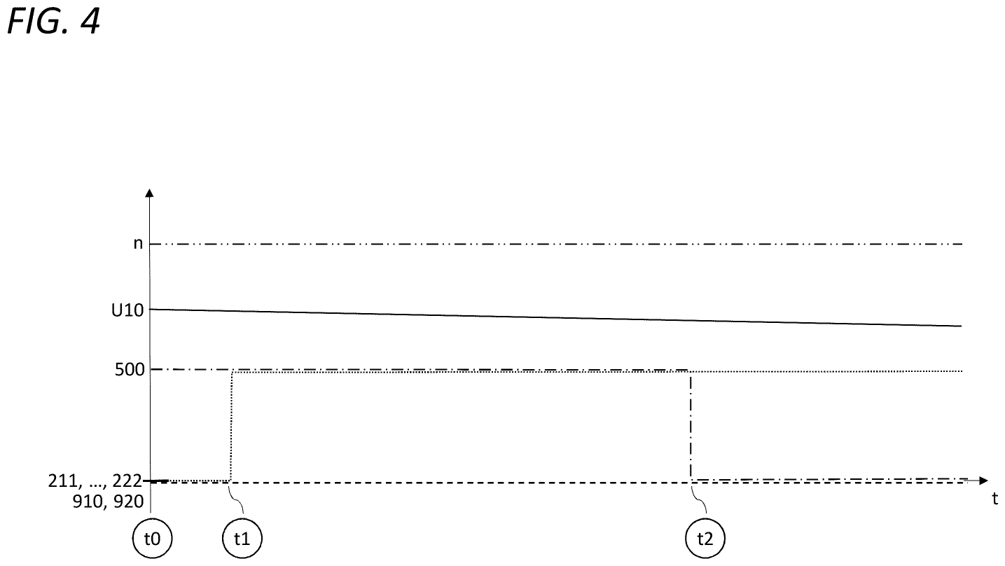

FIG. 4 shows a time course of defined operating information during execution of the first embodiment of the method according to the present disclosure in a schematic illustration as a function of a second operating event.

FIG. 4 shows a chronological course of defined operating information in analogy to FIG. 3. For an explanation of this, reference is made to the description of FIG. 3.

At time t0, the tool 1 is in an operating state in the form of an idle state, in which the drive unit M is in movement and rotates at a more or less constant rotational speed n as the idle speed, at least for a defined period of time. Furthermore, no load is applied to the drive unit M and no electrical energy is provided by the supply devices 910, 920 to drive the drive unit M.

At time t1, a disconnection process of the supply devices 910, 920 from the tool 1 takes place as a second operating event, so that the contact elements 211, 212, 221, 222 are freely accessible from time t1 (see the course of the dotted line 211, . . . , 222 in FIG. 4). In other words, during operation of the tool 1, the supply devices 910, 920 are removed from the tool 1.

Detecting the disconnection process and/or the disconnection state is carried out by the microprocessor module 400 of the tool 1, in particular by transmitting at least one communication signal S from the supply devices 910, 920 to the intermediate circuit 10 and/or to the microprocessor module 400, and/or from the microprocessor module 400 to the supply devices 910, 920. The at least one communication signal S is configured for verification of the presence and/or absence of a communication link between the supply devices 910, 920 and the intermediate circuit 10, in particular the microprocessor module 400.

The time t1 represents a defined operating information in the form of a disconnection time from which the absence of a communication link and thus a disconnection process and/or a disconnection state between the tool 1 and the supply devices 910, 920 can be detected. At the defined time t2, after detecting the disconnection process and/or the disconnection state, the circuit arrangement 500 is switched, in particular by the microprocessor module 400 controlling and/or regulating, in order to switch off the voltage U10 of the intermediate circuit 10, so that no voltage U10 is present as voltage U1 at the contact elements 211, 212, 221, 222 at and/or after the time t2.

The contact elements 211, 212, 221, 222 have been in a de-energized state since time t2 as a result of the voltage U1 being switched off by means of the circuit arrangement 500, so that they no longer pose any danger at and/or after time t2.

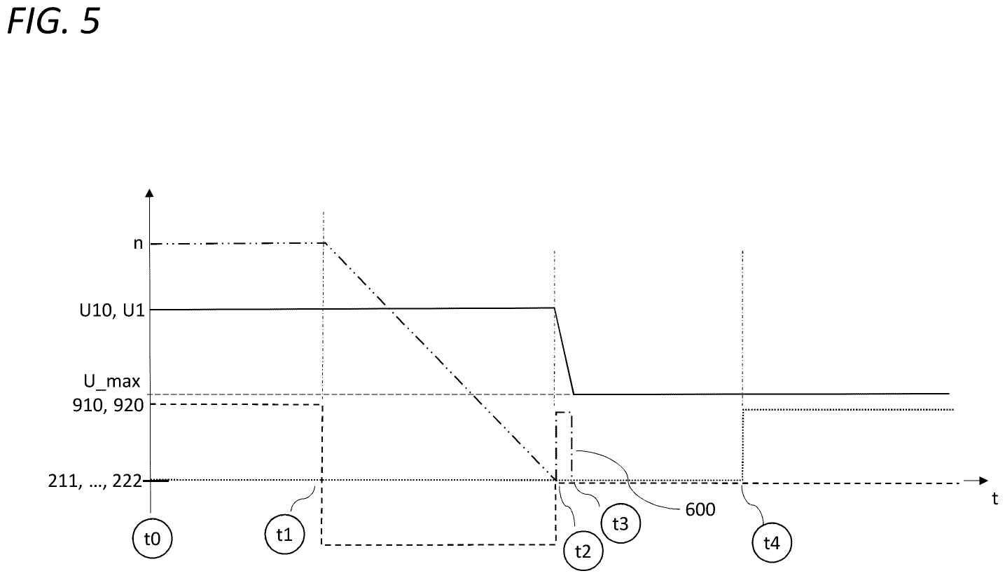

FIG. 5 shows a time course of defined operating information during execution of a second embodiment example of the method according to the present disclosure in a schematic illustration as a function of a first operating event. The second embodiment of the method can be carried out, for example, with the tool 1 according to the second embodiment example as disclosed herein.

FIG. 5 shows a time course of defined operating information analogous to FIG. 3, wherein a time course of the switching position of the circuit arrangement 600 is shown instead of a time course of the switching position of the circuit arrangement 500. For further explanation, reference is made to the description of FIG. 3.

The supply devices 910, 920 are in a connection state at time to and the tool 1 is operated in an intended operating state, i.e. in an activation state, in which electrical energy from the supply devices 910, 920 is provided to the drive unit M in order to drive the at least one tool element.

At time t1, the tool 1 is switched off so that the supply of electrical energy by the supply devices 910, 920 to the drive unit M is interrupted (see the drop in the dashed line 910, 920 at t1 in FIG. 5) and the rotational speed n of the drive unit M decreases to zero by time t2.

When or after the drive unit M reaches a standstill at time t2 after a deceleration period of time as further defined operating information in each case, in which no electrical energy is provided to the drive unit M and/or the drive unit M is stationary, the circuit arrangement 600 is switched, in particular by the microprocessor module 400 controlling and/or regulating, in order to discharge the at least one storage element 120 of the tool 1 and thus the intermediate circuit 10 from time t2, which leads to a reduction of the voltage U10 of the intermediate circuit 10.

Discharging of the at least one storage element 120 by the circuit arrangement 600 takes place between the times t2 and t3, so that a voltage drop is generated at the intermediate circuit 10 and/or at the contact elements 211, 212, 221, 222, in particular to or below a defined maximum voltage value U_max. The maximum voltage value U_max can, for example, be approximately 60 volts.

The voltage drop can be generated within a defined period of time after detecting the disconnection process and/or the disconnection state and can be characterized by at least one of the following curves: an essentially rectangular curve, an essentially linear curve, and/or an essentially exponential curve;

At time t4, a disconnection process of the supply devices 910, 920 from the tool 1 takes place as the first operating event, so that the contact elements 211, 212, 221, 222 are freely accessible from time t4 (see the course of the dotted line 211, . . . , 222 in FIG. 5). The voltage U1 present to the contact elements 211, 212, 221, 222 is essentially equal to or below the defined maximum voltage value U_max due to the voltage drop of the voltage U10 of the intermediate circuit 10 as a result of the discharging process by switching the circuit arrangement 600, so that t4 they no longer pose any danger at and/or after time t4.

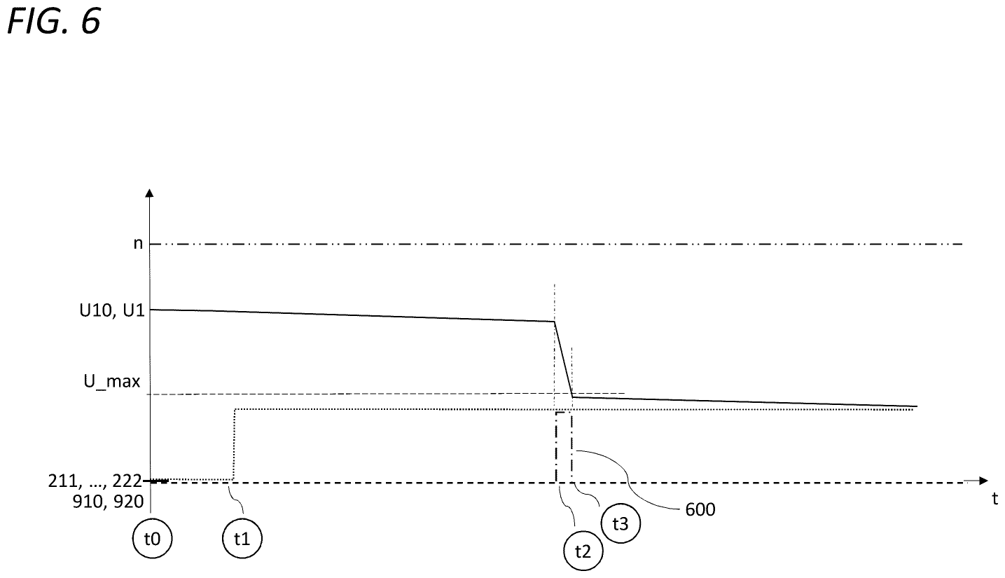

FIG. 6 shows a time course of defined operating information during execution of the second embodiment of the method according to the present disclosure in a schematic illustration as a function of a second operating event.

FIG. 6 shows a time course of defined operating information analogous to FIG. 3, wherein instead of a time course of the switching position of the circuit arrangement 500, a time course of the switching position of the circuit arrangement 600 is shown. For further explanation, reference is made to the description of FIG. 3.

At time t0, the tool 1 is in an operating state in the form of an idle state, in which the drive unit M is in movement and rotates at a more or less constant rotational speed n as the idle speed, at least for a defined period of time. Furthermore, no load is present to the drive unit M and no electrical energy is provided by the supply devices 910, 920 to drive the drive unit M.

At time t1, a disconnection process of the supply devices 910, 920 from the tool 1 takes place as a second operating event, so that the contact elements 211, 212, 221, 222 are freely accessible from time t1 (see the course of the dotted line 211, . . . , 222 in FIG. 6). In other words, during operation of the tool 1, the supply devices 910, 920 are removed from the tool 1.

Detecting the disconnection process and/or the disconnection state is carried out by the microprocessor module 400 of the tool 1, in particular by transmitting at least one communication signal S from the supply devices 910, 920 to the intermediate circuit 10 and/or to the microprocessor module 400, and/or from the microprocessor module 400 to the supply devices 910, 920. The at least one communication signal S is configured for verification of the presence and/or absence of a communication link between the supply devices 910, 920 and the intermediate circuit 10, in particular the microprocessor module 400.

The time t1 represents a defined operating information in the form of a disconnection time from which the absence of a communication link and thus a disconnection process and/or a disconnection state between the tool 1 and the supply devices 910, 920 can be detected. At the defined time t2, after detecting the disconnection process and/or the disconnection state, the circuit arrangement 600 is switched, in particular by the microprocessor module 400 controlling and/or regulating, in order to discharge the at least one storage element 120 of the tool 1 and thus the intermediate circuit 10 from the time t2, which leads to a reduction of the voltage U10 of the intermediate circuit 10.

Discharging of the at least one storage element 120 by the circuit arrangement 600 takes place between the times t2 and t3, so that a voltage drop is generated at the intermediate circuit 10 and/or at the contact elements 211, 212, 221, 222, in particular to or below a defined maximum voltage value U_max. The maximum voltage value U_max can, for example, be approximately 60 volts.

The voltage drop can be generated within a defined period of time after detecting the disconnection process and/or the disconnection state and can be characterized by at least one of the following curves: an essentially rectangular curve, an essentially linear curve, and/or an essentially exponential curve;

The present disclosure is not limited to the embodiments described above. Rather, a large number of variants and modifications are possible which also make use of the inventive concept and therefore fall within the scope of protection. In particular, the present disclosure also claims protection for the subject matter and features of the subclaims independently of the referenced claims.

### LIST OF REFERENCE SYMBOLS

1 tool
10 intermediate circuit
100 drive unit circuit
110 switching module
111 switching unit
112 switching unit
113 switching unit
114 switching unit
115 switching unit
116 switching unit
120 storage element
200 protection module
210 protection unit
220 protection unit
211 load contact element
212 load contact element
213 signal contact element
221 load contact element
222 load contact element
223 signal contact element
300 current limiting module
310 switching unit
320 Switching unit
330 Switching unit
400 microprocessor module
410 computing unit
420 interface unit, memory unit (RAM, flash), etc.
500 voltage control module
510 switching unit
520 switching unit
600 storage control module
610 switching element
620 resistor element
710 sensor unit
720 sensor unit
730 sensor unit
810 communication unit
910 supply device
911 load contact element
912 load contact element
913 signal contact element
920 supply device
921 load contact element
922 load contact element
923 signal contact element
L1 main line
L2 main line
M drive unit
M1 phase line
M2 phase line
M3 phase cable
U1 voltage
U10 voltage
U_max maximum voltage value
n rotational speed
t time
t0 time
t1 time
t2 time
t3 time
t4 time

What is claimed is:

1. A tool comprising:
a drive unit configured to convert electrical energy to drive at least one tool element of the tool;
at least one contact element for transmitting electrical energy and/or electrical signals,
wherein the at least one contact element is configured to form a disconnectable terminal connection with at least one supply device for providing electrical energy and/or electrical signals in order to be able to provide electrical energy and/or electrical signals to the drive unit in a connection state of the at least one supply device; and
an intermediate circuit that electrically connects the drive unit to the at least one contact element,
wherein the intermediate circuit comprises a circuit arrangement that is configured for reducing and/or switching off an electrical voltage which is present at the at least one contact element after a disconnection process of the at least one supply device and/or in a disconnection state of the at least one supply device as a function of at least one defined operating information.

2. The tool according to claim 1,
wherein the at least one defined operating information comprises an operating state of the drive unit and/or a change in the operating state of the drive unit in each case for a defined and/or recorded period of time before the disconnection process and/or before the disconnection state and/or
wherein the at least one defined operating information comprises an operating state of the drive unit and/or a change in the operating state of the drive unit in each case for a defined and/or recorded period of time after the disconnection process and/or during the disconnection state.

3. The tool according to claim 1, wherein the at least one defined operating information comprises at least one of the following operating states:
an activation state of the drive unit, in which electrical energy of the at least one supply device is provided to the drive unit in order to drive the at least one tool element,
a generator state of the drive unit, in which the drive unit generates electrical energy and feeds it into the intermediate circuit, and
a standstill of the drive unit, in which no electrical energy is supplied to the drive unit and/or the drive unit is stationary.

4. The tool according claim 1,
wherein the at least one defined operating information comprises an operating parameter of the intermediate circuit and/or a change of the operating parameter of the intermediate circuit in each case for a defined and/or recorded period of time before the disconnection process and/or before the disconnection state, and/or
wherein the at least one defined operating information comprises an operating parameter of the intermediate circuit and/or a change of the operating parameter of the intermediate circuit in each case for a defined and/or recorded period of time after the disconnection process and/or during the disconnection state.

5. The tool according to claim 1,
wherein the at least one defined operating information comprises an operating parameter of the drive unit and/or a change of the operating parameter of the drive unit in each case for a defined and/or recorded period of time before the disconnection process and/or before the disconnection state, and/or
wherein the at least one defined operating information comprises an operating parameter of the drive unit and/or a change in the operating parameter of the drive unit in each case for a defined and/or recorded period of time after the disconnection process and/or during the disconnection state.

6. The tool according to claim 1, wherein the at least one defined operating information comprises at least one recorded voltage value or at least one recorded voltage value curve, which in each case is associated with at least one of the following components of the tool:
the at least one contact element,
the drive unit,
at least one main line of the intermediate circuit between the at least one contact element and the circuit arrangement,
at least one main line of the intermediate circuit between the circuit arrangement and a drive unit circuit for the drive unit, and/or
at least one main line of the intermediate circuit between the at least one contact element and a drive unit circuit for the drive unit, which comprises the circuit arrangement.

7. The tool according to claim 1,
wherein the circuit arrangement is arranged and/or configured to reduce an applied voltage within a defined period of time after detecting the disconnection process and/or the disconnection state, and/or
wherein the circuit arrangement is arranged and/or configured to reduce a voltage value of a present voltage at least to or below a defined maximum voltage value after detecting the disconnection process and/or the disconnection state.

8. The tool according to claim 1, wherein the circuit arrangement comprises a voltage control module for the at least one contact element, which is arranged between the at least one contact element and a drive unit circuit for the drive unit.

9. The tool according to claim 8,
wherein the voltage control module comprises at least one switching unit with at least one switching element, and
wherein the at least one switching element is formed as at least one of the following switching elements or comprises at least one of the following switching elements: a metal-oxide semiconductor field-effect transistor and a bipolar transistor with an insulated gate electrode.

10. The tool according to claim 1, wherein the circuit arrangement comprises a storage control module for at least one storage element of a drive unit circuit for the drive unit.

11. The tool according to claim 10, wherein the storage control module comprises at least one switching element and at least one resistor element that are arranged in a series circuit with respect to one another.

12. The tool according to claim 1, further comprising: at least one sensor unit for recording the at least one defined operating information.

13. A method for operating a tool, wherein the tool comprises a drive unit for converting electrical energy to drive at least one tool element of the tool, at least one contact element for transmitting electrical energy and/or electrical signals, at least one supply device for providing electrical energy and/or electrical signals and the at least one contact element form a disconnectable terminal connection in order to be able to provide electrical energy and/or electrical signals to the drive unit in a connection state of the at least one supply device, and an intermediate circuit with a circuit arrangement which electrically connects the drive unit to the at least one contact element, the method comprising:
detecting a disconnection process and/or a disconnection state between the at least one supply device and the at least one contact element;
recording an electrical voltage which is present at the at least one contact element; and
reducing and/or switching off the electrical voltage at the at least one contact element by the circuit arrangement as a function of at least one defined operating information.

14. The method according to claim 13, wherein reducing the electrical voltage comprises:
generating a voltage drop at the at least one contact element by the circuit arrangement within a defined period of time after detecting the disconnection process and/or the disconnection state; and
generating a voltage drop at the at least one contact element by the circuit arrangement to or below a defined maximum voltage value.

15. The method according to claim 13, wherein detecting the disconnection process comprises:
transmitting at least one communication signal from the at least one supply device to the intermediate circuit and/or from the intermediate circuit to the at least one supply device,
wherein the at least one communication signal is configured to verify a presence and/or absence of a communication link between the at least one supply device and the intermediate circuit; and
evaluating the transmitted at least one communication signal and identifying the connection state, the disconnection process, and/or the disconnection state as a function of the evaluated at least one communication signal,
wherein evaluating the transmitted at least one communication signal comprises:
comparing with at least one communication reference signal and/or at least one communication threshold signal as a function of at least one comparison parameter and/or storing the transmitted at least one communication signal.

16. The method according to claim 13, wherein recording of the electrical voltage comprises:
measuring at least one voltage value or at least one voltage value curve at the at least one contact element by at least one sensor unit of the tool; and
reducing the electrical voltage if the measured at least one voltage value or the measured at least one voltage value curve is in each case equal to or greater than a defined maximum voltage value or a defined maximum voltage value curve, or if the measured at least one voltage value or the measured at least one voltage value curve is in each case equal to or less than a defined maximum voltage value or a defined maximum voltage value curve.

17. The method according to claim 13, wherein recording of the electrical voltage comprises:
measuring at least one voltage value or at least one voltage value curve at the at least one contact element by at least one sensor unit of the tool; and
switching off the electrical voltage if the measured at least one voltage value or the measured at least one voltage value curve is in each case equal to or greater than a defined maximum voltage value or a defined maximum voltage value curve, or if the measured at least one voltage value or the measured at least one voltage value curve is in each case equal to or less than a defined maximum voltage value or a defined maximum voltage value curve.

18. The method according to claim 13, comprising:
recording a deceleration period of time between a detection of the disconnection process and the drive unit reaching a standstill, during which no electrical energy is provided to the drive unit and/or in which the drive unit is stationary; and
reducing and/or switching off the electrical voltage at the at least one contact element as a function of the recorded deceleration period of time.
